(19) United States
(12) Patent Application Publication
(10) Pub. No.: US 2011/0253260 A1
(43) Pub. Date: Oct. 20, 2011

(54) WOOD CUTTING MACHINE WITH A FINE ADJUSTMENT DEVICE

(76) Inventor: Richard Chang, Fan Yuan City (TW)

(21) Appl. No.: 12/760,283

(22) Filed: Apr. 14, 2010

(51) Int. Cl. B27C 1/00

(52) U.S. Cl. 144/218

(57) ABSTRACT

A fine adjustment device is provided on a cutting wheel of a wood cutting machine. The fine adjustment device includes two lift units and a driving rod. The two lift units are disposed at two ends of the cutting wheel. The driving rod is axially disposed at one side of the cutting wheel and connected to the two lift units for driving the lift units to simultaneously move the two ends of the cutting wheel up or down, decreasing the height error of the two ends of the cutting wheel and enhancing the processing accuracy and grind quality.

### BACKGROUND OF THE INVENTION

1. Field of the Invention

The present invention relates to a wood cutting machine with a fine adjustment device.

2. Description of the Prior Art

As shown in FIG. 1, a conventional wood cutting machine comprises a base 1. The base 1 comprises a worktable 2 thereon. A cutting unit 3 is provided above the worktable 2. The cutting unit 3 comprises a coarse abrasive wheel 4 and a fine abrasive wheel 5 to grind a workpiece 6. The coarse abrasive wheel 4 of the conventional wood cutting machine is used for coarse grind of the workpiece 6. The fine abrasive wheel 5 is used for fine grind of the workpiece 6. The particle size of the coarse abrasive wheel 4 is greater than that of the fine abrasive wheel 5, and the diameter of the fine abrasive wheel 5 is smaller than that of the coarse abrasive wheel 4. Two ends of the fine abrasive wheel 5 are respectively provided with an adjustment device 7 to adjust the grind position of the fine abrasive wheel 5 relative to the coarse abrasive wheel 4. Generally, the adjustment device 7 is composed of a screw and a slide block. The adjustment devices 7 at the two ends of the fine abrasive wheel 5 are separately operated to adjust the position of the fine abrasive wheel 5. After several adjustments, the two ends of the fine abrasive wheel 5 may be not at the same height, which influences the grind effect of the workpiece 6. Accordingly, the inventor of the present invention has devoted himself based on his many years of practical experiences to solve this problem.

### SUMMARY OF THE INVENTION

The present invention is to provide a wood cutting machine with a fine adjustment device. The wood cutting machine comprises a worktable and a cutting unit located above the worktable. The cutting unit has a base. The base comprises at least one cutting wheel and the fine adjustment device thereon. The fine adjustment device comprises two lift units and a driving rod. The two lift units are disposed at two ends of the cutting wheel. The driving rod is axially disposed at one side of the cutting wheel and connected to the two lift units for driving the lift units to simultaneously move the two ends of the cutting wheel up or down. The present invention not only improves the height error of the conventional wood cutting machine but also enhances the processing accuracy and grind quality. With the fine adjustment device, the position of the cutting wheel can be adjusted quickly to increase the efficiency of processing.

### BRIEF DESCRIPTION OF THE DRAWINGS

FIG. 1 is a perspective view of a conventional wood cutting machine;

FIG. 2 is a partially exploded view according to a preferred embodiment of the present invention;

FIG. 3 is a partially cross-sectional view according to the preferred embodiment of the present invention;

FIG. 4 is a partially enlarged perspective view according to the preferred embodiment of the present invention;

FIG. 5 is a perspective view showing the fine adjustment device of the present invention;

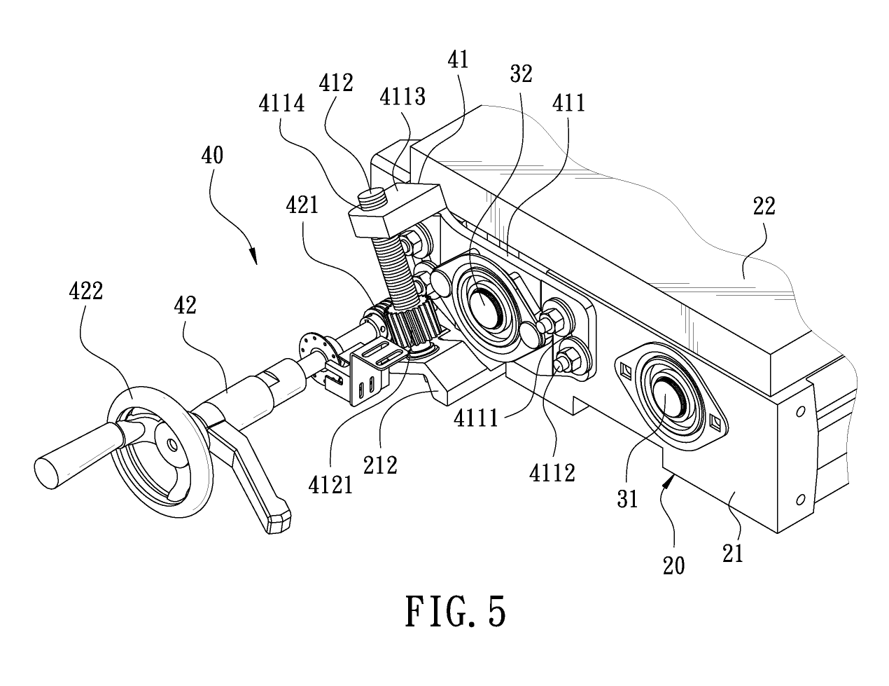

FIG. 6 is a front view showing the fine adjustment device of the present invention; and

FIG. 7 is a schematic view showing another use of the present invention.

### DETAILED DESCRIPTION OF THE PREFERRED EMBODIMENTS

Embodiments of the present invention will now be described, by way of example only, with reference to the accompanying drawings.

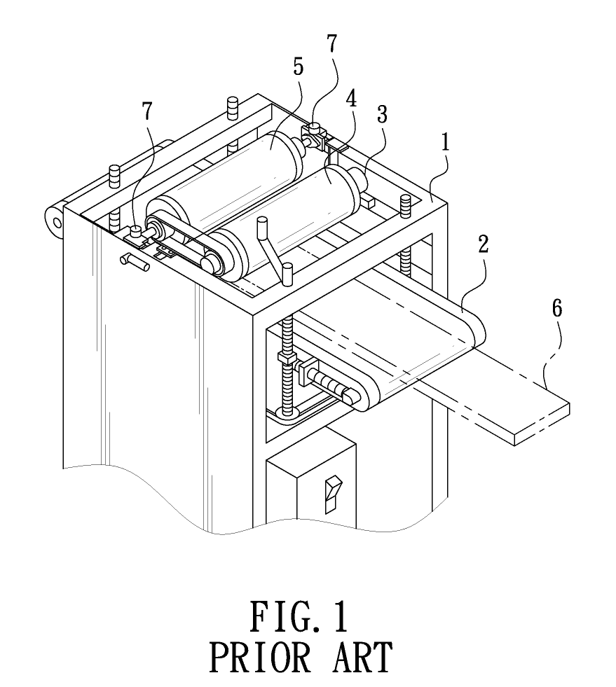

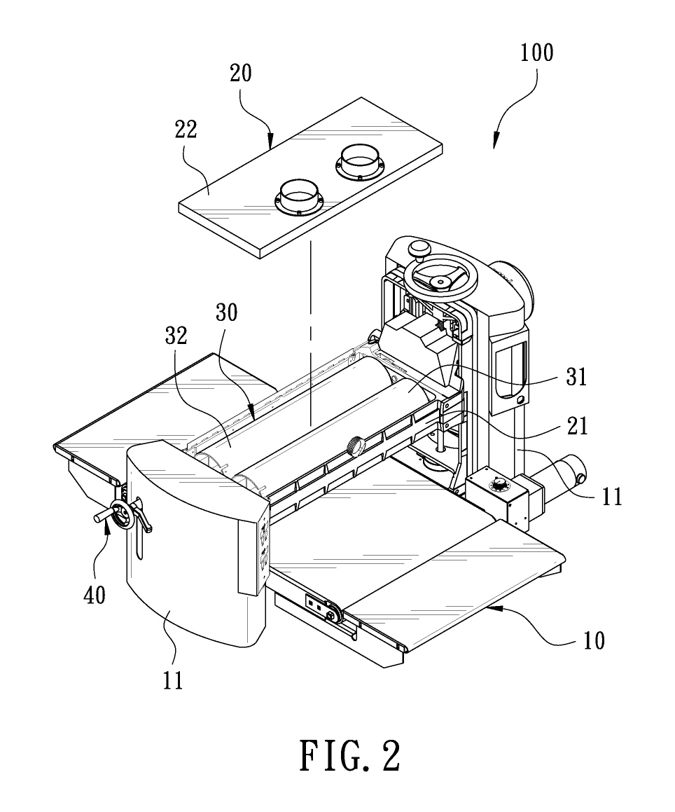

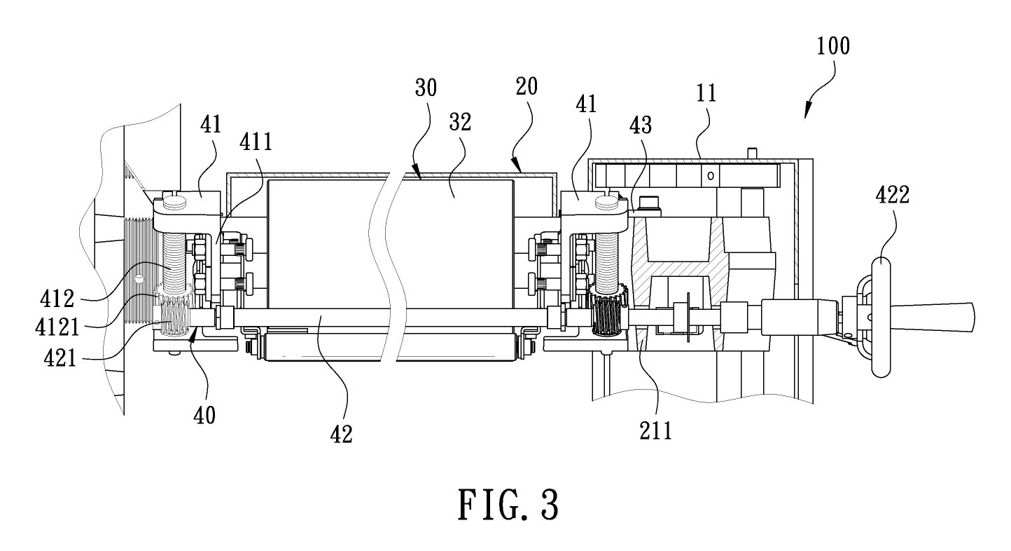

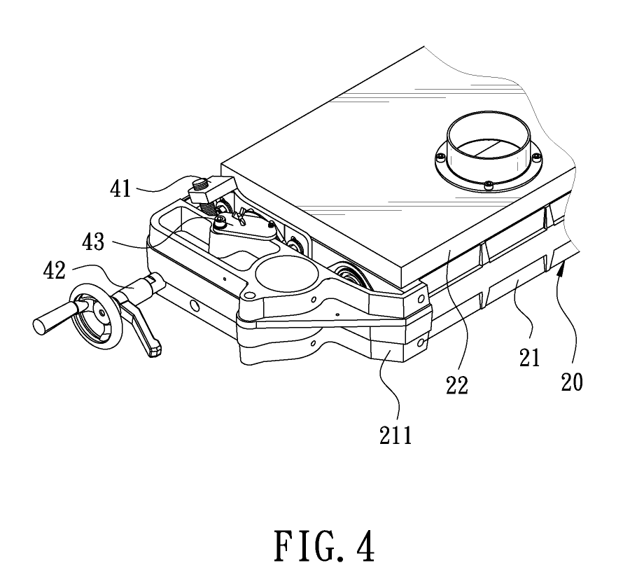

As shown in FIGS. 1 to 3, a wood cutting machine 100 according to a preferred embodiment of the present invention comprises a worktable 10. The worktable 10 comprises a pair of slide seats 11 at two sides thereof. A cutting unit 20 is provided between the pair of slide seats 11. The cutting unit 20 comprises a hollow base 21. As shown in FIG. 4, the base 21 has a pair of connection seats 211 at two sides thereof. The connection seats 211 are slidably connected to the slide seats 11. At least one cutting wheel 30 is provided in the base 21. The cutting wheel 30 is a cutter wheel or an abrasive wheel. In this embodiment, there are two cutting wheels 30 in the base 21. The two cutting wheels 30 are a coarse abrasive wheel 31 and a fine abrasive wheel 32. An upper lid 22 is provided on the base 21. A fine adjustment device 40 is provided on the base 21. The fine adjustment device 40 comprises two lift units 41, a driving rod 42, and a return-to-zero plate 43.

The two lift units 41 are disposed at two ends of the fine abrasive wheel 32. Each lift unit 41 comprises a positioning plate 411 and a screw 412. The positioning plate 411 is pivotally connected to one end of the fine abrasive wheel 32. The positioning plate 411 has two slide slots 4111 disposed close to two ends of the positioning plate 411. The positioning plate 411 is slidably connected to the base 21 of the cutting unit 20 through two bolts 4112. The positioning plate 411 has a connection block 4113 protruding from an upper end thereof. The connection block 4113 has a threaded hole 4114. The base 21 has an extension block 212 corresponding to the connection block 4113. One end of the screw 412 is screwed to the threaded hole 4114, while another end of the screw 412 is provided with a worm gear 4121 and pivotally connected to the extension block 212 of the base 21. The screw 412 is parallel to the slide slot 4111 of the positioning plate 411.

The driving rod 42 is axially disposed at one side of the fine abrasive wheel 32, opposite to the coarse abrasive wheel 31. The driving rod 42 has a threaded section 421 adjacent to the lift unit 41 to mesh with the worm gear 4121 of the lift unit 41. One end of the driving rod 42 is connected with a hand wheel 422.

The return-to-zero plate 43, as shown in FIG. 4, is pivotally connected to the connection seat 211 of the base 21 and located close to the positioning plate 411.

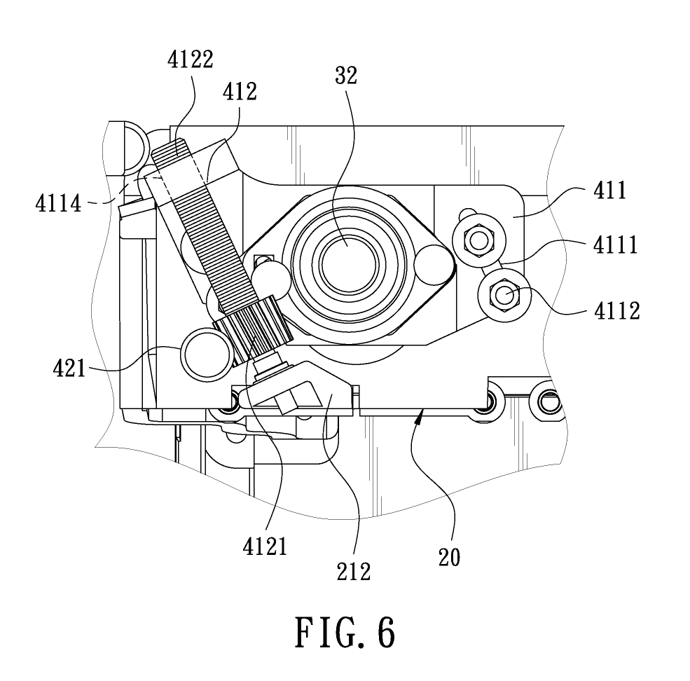

FIG. 6 is a front view showing the fine adjustment device of the present invention. When the user wants to adjust the position of the fine abrasive wheel 32 relative to the coarse abrasive wheel 31, the user can turn the hand wheel 422 to drive the driving rod 42 and link the screws 412 of the lift units 41 at the two ends of the fine abrasive wheel 32 to turn. Because one end of the screw 412, opposite to the threaded hole 4114, is pivotally connected to the extension block 212 of the base 21, the screw 412 will be moved in the threaded hole 4114. The positioning plate 411 is guided by the slide slot 4111 to move the fine abrasive wheel 32 up or down simultaneously. Thus, the present invention not only improves the height error of the conventional wood cutting machine but also enhances the processing accuracy and grind quality. The position of the fine abrasive wheel 32 can be adjusted quickly to increase the efficiency of processing. Besides, with the return-to-zero plate 43, the present invention provides a quick positioning effect to assist the fine abrasive wheel 32 in returning to zero.

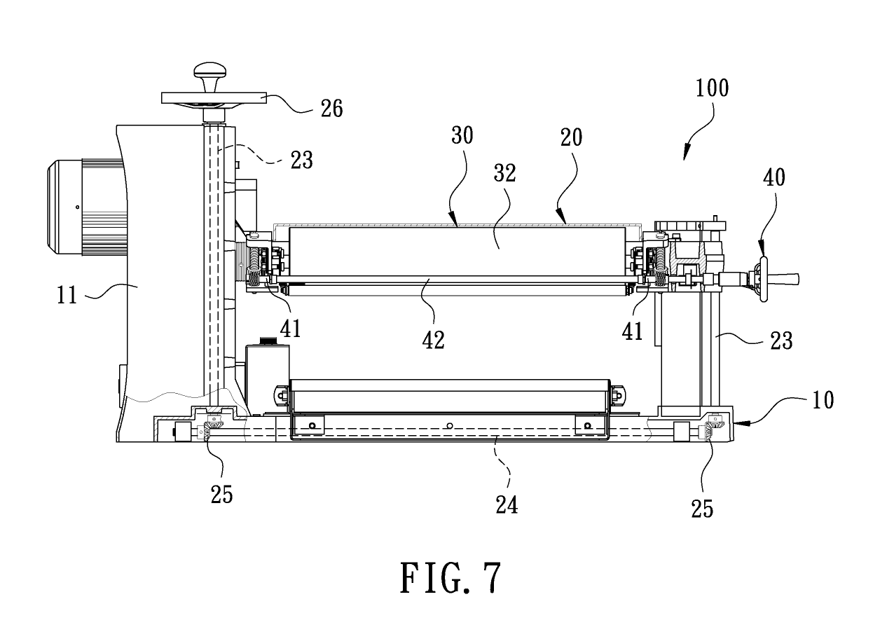

FIG. 7 is a schematic view showing another use of the present invention. The cutting unit 20 of the wood cutting machine 100 is slidably connected above the worktable 10, and its position must be adjusted according to the thickness of a processing plank. As shown in FIG. 7, two ends of the cutting unit 20 are connected with screws 23, respectively. A transmission rod 24 is provided under the worktable 10. A bevel gear 25 is provided between the screw 23 and the transmission rod 24 to connect with the screw 23 and the transmission rod 24. One of the screws 23 is connected with a hand wheel 26. The user can turn the hand wheel 26 to drive the cutting unit 20 to move up or down relative to the worktable 10, achieving the same effect of the preferred embodiment of the present invention so as to enhance the processing quality.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A wood cutting machine with a fine adjustment device, the wood cutting machine comprising a worktable and a cutting unit located above the worktable, the cutting unit having a base, the base comprising at least one cutting wheel and the fine adjustment device thereon, the fine adjustment device comprising:
two lift units disposed at two ends of the cutting wheel; and
a driving rod axially disposed at one side of the cutting wheel and connected to the two lift units for driving the lift units to simultaneously move the two ends of the cutting wheel up or down.

2. The wood cutting machine with a fine adjustment device as claimed in claim 1, wherein the cutting wheel is a cutter wheel.

3. The wood cutting machine with a fine adjustment device as claimed in claim 1, wherein the cutting wheel is an abrasive wheel.

4. The wood cutting machine with a fine adjustment device as claimed in claim 1, wherein the driving rod has a threaded section adjacent to each of the lift units, each of lift units comprising a positioning plate and a screw, the positioning plate being pivotally connected to one end of the cutting wheel, the positioning plate having a connection block protruding from an upper end thereof, the connection block having a threaded hole, one end of the screw being screwed to the threaded hole, another end of the screw being provided with a worm gear and pivotally connected to the base, the worm gear meshing with the threaded section of the driving rod, the driving rod driving the screw to move the positioning plate and link the cutting wheel to move up or down.

5. The wood cutting machine with a fine adjustment device as claimed in claim 4, wherein the fine adjustment device further comprises a return-to-zero plate, the return-to-zero plate being pivotally connected to the base and located close to the positioning plate.

6. The wood cutting machine with a fine adjustment device as claimed in claim 1, wherein one end of the driving rod is connected with a hand wheel.

7. The wood cutting machine with a fine adjustment device as claimed in claim 1, wherein each of the two ends of the cutting unit is connected with a screw, a transmission rod being provided under the worktable, a bevel gear being provided between the screw and the transmission rod to connect with the screw and the transmission rod.
